(19) United States
(12) Patent Application Publication
(10) Pub. No.: US 2015/0341667 A1
(43) Pub. Date: Nov. 26, 2015

(54) VIDEO QUALITY MODEL, METHOD FOR TRAINING A VIDEO QUALITY MODEL, AND METHOD FOR DETERMINING VIDEO QUALITY USING A VIDEO QUALITY MODEL

(71) Applicant: THOMSON LICENSING, Issy-Les-Moulineaux (FR)

(72) Inventors: Ning LIAO, Beijing (CN); Zhibo CHEN, Beijing (CN); Fan ZHANG, Hubel (CN)

(73) Assignee: Thomson Licensing

(21) Appl. No.: 14/654,536

(22) PCT Filed: Dec. 21, 2012
(86) PCT No.: PCT/CN2012/087206

§ 371 Date: Jun. 21, 2015

(51) Int. Cl. H04N 19/895; H04N 19/139; H04N 19/154; H04N 19/86

(52) U.S. Cl. CPC H04N 19/895; H04N 19/86; H04N 19/139; H04N 19/154

(57) ABSTRACT

A big challenge for Video Quality Measurement on bitstream-level, especially in the case of network impairment, is to predict the quality level of Error Concealment artifacts at the bitstream level before decoding the video. The present invention is based on the recognition of the fact that the effectiveness of various EC methods can be estimated from some common content features and compression technique features. The invention comprises selecting training data frames of a predefined type, analyzing predefined typical features of the selected training data frames, decoding the training data frames using the target video decoder, wherein the decoding may comprise EC, and performing video quality measurement. The video quality of the decoded and error concealed training data frames is measured or estimated using a reference VQM model.

### FIELD OF THE INVENTION

This invention relates to a Video Quality Model, a method for training a Video Quality Model and a corresponding device.

### BACKGROUND

As IP networks develop, video communication over wired and wireless IP network (e.g. IPTV service) has become very popular. Unlike traditional video transmission over cable network, video delivery over IP network is much less reliable. The situation is even worse in the environment of wireless networks. Correspondingly, a requirement for Video Quality Modeling and/or Video Quality Measuring (both being denoted VQM herein) is to rate the quality degradation caused by IP transmission impairment (e.g. packet loss, delay, jitter), in addition to that caused by video compression.

When parts of the coded video bitstream are lost during network transmission, the decoder may employ Error Concealment (EC) methods to conceal the lost parts in an effort to reduce the perceptual video quality degradation. However, usually a loss artifact remains after concealment. The less visible the concealed loss artifact is, the more effective is the EC method. The EC effectiveness depends heavily on the video content features and the video compression techniques used.

Rating of EC artifacts determines the initial visible artifact (IVA) level when a packet loss occurs. Further, the IVA will propagate spatio-temporally to the areas that use it as a reference in a predictive video coding framework, like in H.264, MPEG-2, etc. Accurate prediction of the EC artifact level is a fundamental part of VQM for measuring transmission impairment. Different visibility of EC artifacts results from the different EC strategies implemented in the respective decoders. However, the EC method employed by a decoder is not always known before decoding the video.

Thus, one big challenge for VQM on bitstream-level, in particular in the case of network impairment, is to predict the quality level of EC artifacts at the bitstream level before decoding the video. Known solutions that deal with this challenge assume that the EC method used at the decoder is known. But a big problem is that, in practice, there are various versions of implementation of decoders that employ various different EC strategies. EC methods roughly fall into two categories: spatial approaches and temporal approaches. In the spatial category, the spatial correlation between local pixels is exploited, and missing macroblocks (MBs) are recovered by interpolation techniques from the neighboring pixels. In the temporal category, both the coherence of motion fields and the spatial smoothness of pixels along edges across block boundaries are exploited to estimate the motion vector (MV) of a lost MB. In various decoder implementations, these EC methods may be used in combination.

A full-reference (FR) image quality assessment method known in the prior art [1] is limited to a situation where the original frames that do not suffer from network transmission impairment are available. However, in realistic multimedia communication the original signal is often not available. A known no-reference (NR) image quality assessment model [2] is more consistent with realistic video communication situations, but it is not adaptive with respect to EC strategies. An enhanced VQM would be desirable that is capable of adapting automatically to different EC strategies of different decoder implementations that are not known beforehand.

### SUMMARY OF THE INVENTION

The present invention is based on the recognition of the fact that the effectiveness of various EC methods can be estimated from some common content features and compression technique features. This is valid even if different EC methods are applied to the same case of lost content, which may lead to different EC artifacts levels, such as e.g. spatial EC methods and temporal EC methods. Spatial EC methods recover missing macroblocks (MBs) by interpolation from the neighboring pixels, while temporal EC methods exploit the motion field and the spatial smoothness of pixels on block edges. The invention provides a method and a device for enhanced video quality measurement (VQM) that is capable of adapting automatically to any given decoder implementation that may employ any known or unknown EC strategy. Adaptivity is achieved by training.

Advantageously, the adapted/trained VQM method and device can estimate video quality of a target video when decoded and error concealed by the target video decoder and EC method to be assessed, even without fully decoding and error concealing the target video.

In principle, the present invention comprises selecting training data frames of a predefined type, analyzing predefined typical features of the selected training data frames, decoding the training data frames using the target video decoder (or an equivalent), wherein the decoding may comprise EC, and performing video quality measurement, wherein the video quality of the decoded and error concealed training data frames is measured or estimated using a reference VQM model. The video quality measurement results in a reference VQM metric. Further, a plurality of candidate VQM metrics are calculated from at least some of the analyzed typical features, by a plurality of VQM models (VQMM) or sets of VQM coefficients of at least one given VQMM. The reference VQM metric, candidate VQM metric, and VQMMs or sets of VQM coefficients may be stored. After a plurality of training data frames have been processed in this way, an optimal set of VQM coefficients is determined in an adaptive learning process, wherein the stored candidate VQM metrics are compared and matched with the reference VQM metric. A best-matching candidate VQM metric is determined as optimal VQM metric, and the corresponding VQM coefficients or the VQMM of the optimal VQM measure are stored as the optimal VQMM. Thus, the stored VQMM or VQM coefficients are optimally suitable for determining video quality of a video after its decoding and EC using the target decoder and EC strategy. After the training, the VQM model adapted by the determined and stored VQM coefficients can be applied to the target video frames, thereby constituting an adapted VQM tool.

A metric is generally the result, i.e. measure, that is obtained by a measurement method or device, such as a VQM. That is, each measuring algorithm has its own individual metric.

One particular advantage of the invention is that the training dataset can be automatically generated so as to satisfy certain important requirements defined below. Another advantage of the present invention is that an adaptive learning method is employed, which improves modeling of the EC artifacts level assessment for different or unknown EC methods. That is, a VQM model learns the EC effects without having to know and emulate for the assessment the EC strategy employed in any particular target decoder.

In a first aspect, the invention provides a method and a device for generating a training dataset for adaptive VQM, and in particular for learning-based adaptive EC artifacts assessment. In one embodiment, the whole process is performed totally automatic. This has the advantage that the EC artifacts assessment is quick, objective and reproducible.

In one embodiment, interactions from a user are allowed. This has the advantage that the video quality assessment can be subjectively improved by a user.

In principle, the method for generating a training dataset for adapting adaptive VQM to a target video decoder comprises steps of extracting one or more concealed frames from a training video stream, calculating typical features of the extracted frames, decoding the extracted frames and performing EC, wherein the target video decoder and EC unit (or an equivalent) is used, performing a first quality assessment of the one or more extracted frames by a reference VQM model, and performing a second quality assessment of the extracted one or more frames by a plurality of candidate VQM models, each using at least some of the calculated typical features. The second quality assessment employs a self-learning assessment method, and may generate and/or store a training data set for EC artifact assessment.

In one embodiment, a method for generating a training dataset for EC artifacts assessment comprises steps of extracting one or more concealed frames from a training video stream, determining (e.g. calculating) typical features of the extracted frames, decoding the extracted frames and performing EC by using the target video decoder and EC unit (or equivalent), performing a first quality assessment of the decoded extracted frames using a reference VQM model, performing a second quality assessment of the extracted frames by using for each of the decoded extracted frames a plurality of different candidate VQM models or a plurality of different candidate coefficient sets for at least one given VQMM, wherein at least some of the calculated typical features are used, determining from the plurality of VQMMs or VQMM coefficient sets an optimal VQMM or VQMM coefficient set that optimally matches the result of the first quality assessment, wherein for each of the decoded extracted frames the plurality of candidate VQMs are matched with the result of the reference VQM and wherein an optimal VQMM or set of VQMM coefficients is obtained, and providing (e.g. transmitting, or storing for later retrieval) the optimal VQMM or set of VQMM coefficients for video quality assessment of target videos.

In one embodiment, a device for generating a training dataset for EC artifacts assessment comprises a Concealed Frame Extraction module for extracting one or more concealed frames from a training video stream, decoding the extracted frames and performing EC by using the target video decoder and EC unit (or an equivalent), a Typical Feature Calculation unit for calculating typical features of the extracted frames, a Reference Video Quality Assessment unit for performing a first quality assessment of the decoded extracted frames by using a reference VQM model, and a Learning-based EC Artifacts Assessment Module (LEAAM) for performing a second quality assessment of the extracted frames, the LEAAM having a plurality of different candidate VQM models or a plurality of different candidate coefficient sets for a given VQMM, wherein the plurality of different candidate VQMMs or candidate coefficient sets for a given VQMM use at least some of the calculated typical features and are applied to each of the decoded extracted frames. The Learning-based EC Artifacts Assessment Module further has an Analysis, Matching and Selection unit for determining from the plurality of VQMMs or VQMM coefficient sets an optimal VQMM or VQMM coefficient set that optimally matches the result of the first quality assessment, wherein for each of the decoded extracted frames the plurality of candidate VQMs is matched with the reference VQM and wherein an optimal VQMM or set of VQMM coefficients is obtained, and an Output unit for providing (e.g. storing for later retrieval) the optimal VQMM or set of VQMM coefficients for video quality assessment of target videos.

In a second aspect, the present invention provides a VQM method and a VQM tool for a target video, wherein the VQM method and VQM tool comprises an adaptive EC artifact assessment model trained by the generated training dataset. In particular, the invention provides a method for determining video quality of a video frame by using an adaptive VQM model (VQMM) that was automatically adapted to a target video decoder and target EC module (that may be part of, or integrated in, the target video decoder) by the training dataset generated by the above-described method or device. The VQM method according to the second aspect of the invention comprises steps of extracting one or more frames from a target video stream, calculating typical features of the extracted frames, retrieving a stored VQM model and/or stored coefficients of a VQM model, and performing a video quality assessment of the extracted frames by calculating a video quality metric using the retrieved VQM model and/or coefficients of a VQM model, wherein the calculated typical features are used.

According to the second aspect of the invention, a VQM method that is capable of automatically adapting to a target video decoder comprises steps of configuring a VQM model, wherein a stored VQM model or stored coefficients of a VQM model are retrieved and used for configuring, extracting one or more video frames from a target video sequence, calculating typical features of the extracted one or more frames, calculating typical features of each of the extracted frames, and calculating a video quality metric (e.g. mean opinion score MOS) of the extracted frames, wherein the configured VQM model and at least some of the calculated typical features are used.

Further, the present invention provides a computer readable medium having executable instructions stored thereon to cause a computer to perform a method for generating a training dataset for EC artifacts assessment that is suitable for automatically adapting to a video decoder and EC unit, wherein adaptive learning is used that is adapted by using a training data set as described above.

VQM according to the invention has the capability to learn different EC effects and later recognize them, in order to be able to estimate video quality when the EC strategy of a decoder is unknown. Advantageously, the invention allows predicting the EC artifacts level in the final picture with improved accuracy.

An advantage of the adaptive EC artifacts measurement solution according to the invention over existing VQM methods is that the EC strategy used in a decoder needs not be known in advance. That is, it is advantageous that the VQM needs not be manually selected for a given target decoder and EC unit. A VQM according to the invention can automatically adapt to different decoders and is more interesting and useful from a practical viewpoint, i.e. more flexible, reliable and user-friendly. Further, a VQM according to the invention can be re-configured. Therefore, it can be applied to different decoders and EC methods, and even can, in a simple manner, be re-adjusted after a decoder update and/or an EC method update. As a result, an EC artifacts level in the final picture can be predicted with improved accuracy even before/without full decoding of the picture, since the typical features that are used for calculating the VQM metric can be obtained from the bitstream without full decoding.

A further advantage of the invention is that, in one embodiment, the whole adaptation process is performed automatically and transparent to users. On the other hand, in one embodiment a user may also input his opinion about image quality and let the quality assessment model be finely tuned according to this input.

Advantageous embodiments of the invention are disclosed in the dependent claims, the following description and the figures.

### BRIEF DESCRIPTION OF THE DRAWINGS

Exemplary embodiments of the invention are described with reference to the accompanying drawings, which show in

FIG. 1 a block diagram of decoder-adaptive EC artifacts assessment, using a FR (full-reference) image quality assessment model to rate the extracted frames;

FIG. 2 a block diagram of decoder-adaptive EC artifacts assessment, using a NR (no-reference) image quality assessment model to rate the extracted frames;

FIG. 3 a block diagram of decoder-adaptive EC artifacts assessment, using user input of a viewer to rate the extracted frames;

FIG. 4 the principle of adaptive selection of an optimal VQM model;

FIG. 5 frames having only EC artifacts and frames having propagated artifacts;

FIG. 6 details of the Concealed Frame Extraction module;

FIG. 7 details of an exemplary Learning-based EC Artifacts Assessment Modeling module;

FIG. 8 a) Learning-based EC Artifacts Assessment Modeling module and separate Target Video Quality Assessment module;

FIG. 8 b) Learning-based EC Artifacts Assessment Modeling module with integrated Target Video Quality Assessment module;

FIG. 9 a flow-chart of the method for generating a training dataset;

FIG. 10 a flow-chart of the method for measuring a video quality;

FIG. 11 a flow-chart of a method for adapting a VQM to a given decoding and EC method;

FIG. 12 different exemplary visible artifacts produced by different EC strategies employed at the decoder side for the same video content and lost data;

FIG. 13 a flow-chart of a method for generating a training dataset for adaptive video quality measurement of target videos decoded by a video decoder that comprises error concealment; and

FIG. 14 an embodiment of a Learning-based EC Artifacts Assessment Modeling module.

### DETAILED DESCRIPTION OF THE INVENTION

A decoder-adaptive EC artifacts assessment solution as implemented in a device for generating a training data set, according to various embodiments of the invention, is illustrated in FIGS. 1-3. There are four main modules, namely a Concealed Frames Extraction module (CFE) 201 for extracting one or more concealed frames, a Typical Features Calculation (TFC) module 202 for calculating typical features for the extracted frame or frames, a reference Quality Assessment module 203a, 203b, 203c for assessing a quality of the extracted frame or frames which serves as reference quality, and an Artifacts Assessment module 204 for implementing, adapting and applying a learning-based EC artifacts assessment model. In the following, embodiments are described using different reference methods to obtain the image quality of the extracted frames in the first Quality Assessment module 203a-c, namely full-reference (FR) image quality assessment, no-reference (NR) image quality assessment and subjective quality assessment. The latter allows a user to input his/her opinion about the image quality, as will be described in detail below.

In the embodiment shown in FIG. 1, a FR image quality assessment model is used. Selected source sequences are input as a data stream to a video encoder with a subsequent packetizer 210, such as Real-Time Transport Protocol (RTP) or RTP Transport Stream (TS/RTP) packetizer. The selected source sequences are used as training sequences for adapting and/or optimizing the model. For FR image quality assessment, the packetized correct video data are provided to a video decoder 212 and to a network impairment simulator 211 that inserts errors into the packetized video data. The inserted errors are any type of errors that occurs typically during packet transmission in networks, e.g. packet loss or bit errors. The stream with the impaired packets from the network impairment simulator 211 is provided to a CFE module 201, which is described below in detail. It extracts frames that have lost packets but no propagated artifacts from their prediction reference, performs decoding and error concealment (EC) for the extracted frames, and provides at its output the decoded and error concealed extracted frames. These frames are called Processed Image Sample (PIS) and are described in more detail further below.

The PIS's are provided to a Quality Assessment module 203a-203c, which performs a quality assessment of the extracted frames and derives a numeric quality score NQS (e.g. mean opinion score, MOS) for each PIS. For this purpose, it uses an automatic or subjective quality assessment model (such as e.g. the FR image quality assessment method known from [1] or [2]), as described below. A PIS together with its numeric quality score NQS forms the sample of a training data set TDS, which is then provided to a Learning-based Error Concealment (EC) Artifacts Assessment Modeling module 204. The training data set TDS comprises several, typically up to several hundreds, of such samples.

Further, the CFE module 201 provides data to a Typical Feature Calculation (TFC) module 202, which calculates typical features of the PIS's, i.e. the frames that are extracted in the CFE module 201. For example, the CFE module 201 indicates to the TFC module 202 which of the frames is a PIS, and other information. More details on the features are described below. The calculated typical features TF are also provided to the Learning-based EC Artifacts Assessment Modeling module 204.

The Learning-based EC Artifacts Assessment Modeling (LEAAM) module 204 may store the samples of the training data set TDS in a storage S and creates, adapts and/or—in some embodiments—applies a learning-based EC artifacts assessment model, based on the training data set. In one embodiment described below, the LEAAM module 204 operates only on the training data set in order to obtain an optimized model, which can be defined by optimized model coefficients. In another embodiment, the LEAAM module 204 operates also on the actual video to be assessed. One or more template models that can be parameterized using the obtained optimized coefficients may be available to the LEAAM module 204. The optimized model, or its coefficients respectively, can also be stored in the storage S or in another, different storage (not shown), and can be applied to an actual video to be assessed either within the LEAAM module 204 or in a separate Target Video Quality Assessment module 205 described below. Such separate Target Video Quality Assessment module, e.g. implemented in a processor, may access the stored optimized model or model coefficients that are adapted in the LEAAM module 204.

In the following, more details on the above-mentioned blocks are provided.

Concealed Frame Extraction 201

The Concealed Frame Extraction (CFE) module 201 performs at least full decoding and error concealment (EC) of frames that have lost packets, but that refer to (i.e. are predicted from) correctly received prediction references, so that they have no propagated artifacts from their prediction reference. These are so-called Processed Image Samples (PIS's). The CFE module 201 decodes also their prediction references, since they are necessary for decoding the PIS's. In one embodiment, also frames that are necessary for EC of PIS's are decoded. Further, the CFE module 201 provides at its output the de-coded and error concealed PIS's at least to the Quality Assessment Module 203a-203c. In one embodiment, the CFE module 201 extracts and processes only predicted frames (i.e. frames that were decoded using prediction). In some simple decoders, no error concealment strategy is implemented at all and the lost data is left empty (pixels are grey). In this case, the PIS is the target frame after full decoding, and “no error concealment” is regarded as a special case of error concealment strategy.

FIG. 5 shows a sequence of frames having no other artifacts than EC artifacts. The series 50 comprises intra-coded frames (marked “I-frame”), predicted frames (“P-frame”) and bi-directionally predicted frames (“B-frame”). If one or more packets are lost, the corresponding area 52 of the frame contains artifacts. If this area is in a frame n that is used for prediction of other frames n+1, . . . , n+5, the error may propagate to the predicted frames. In the example shown, an error in an area 52 within a P-frame n occurs, and propagates to a subsequent P-frame n+3 and B-frames n+1, n+2, n+4, n+5. As a result of motion compensation, the disturbed area 54,55 in the predicted frames is often (like in this example) larger than the area 52 in the frame n with the actual packet loss. Similarly, it may happen that a packet loss occurring in an area 53 of a P-frame n+3 propagates to subsequent B-frames n+4, n+5 predicted from the P-frame n+3, but due to motion compensation the disturbed area 56,57 in the predicted frames is smaller than the area 53 in the frame n+3 with the actual packet loss, as in this example. The artifacts may propagate until the next I-frame n+6 occurs, e.g. at the beginning of the next group of pictures (GOP). Thus, the number of affected frames depends on the image content (e.g. motion) and GOP size. In the example shown in FIG. 5, only one frame 52 can serve as a PIS, according to one embodiment, since the other frames have either no disturbed area or inherited disturbed areas (i.e. areas that are predicted from disturbed areas).

FIG. 6 shows an exemplary implementation of the CFE module 201 comprising a de-packetizer 61, parser 62 and an EC video decoder 65 (the parser 62 may but needs not be integrated in the EC Video Decoder 65). A coded packetized video bitstream formatted according to a transport protocol, e.g. RTP or TS/RTP packet stream, is input to the de-packetizer 61 for the respective transport protocol. The CFE module 201 may also comprise a plurality of different de-packetizers for different transport protocols. In one embodiment (if applicable, e.g. for RTP), frames having lost packets are identified by analyzing the packet header of the transport protocol, e.g. by checking the discontinuity of the “sequence number” field of the RTP header in the case of RFC3350 compliant packets and/or the “continuity_counter” field of the TS header syntax in the case of ITU-T Rec. H.222.0 compliant packets. If a packet is partly or completely lost, its index IDX is provided to the EC Video Decoder 65. Also the coded video bitstream CBS is provided to the EC Video Decoder 65. In the EC Video Decoder 65, the syntax of the coded frames in the same IDR frame gap (interval between two IDR frames) as the frame having a lost packet are parsed in a parser 62 for further identifying coded distorted frames (as described above, e.g. frame 52 in FIG. 5) in a Distorted Frame Detector 66. These are the frames that have only EC artifacts, and they are also called target extracted frames or target frames herein. The index IDX of a partly or completely lost packet is also provided to the TFC module 202, which uses the information for identifying the frames of which it calculates typical features.

Taking an ITU-T Rec. H.264 standard coded bitstream as example, the “slice type” and “frame_num” fields of the slice header syntax and the “max_num_ref_frames” of sequence parameter set syntax are parsed 62 to identify one or more frames having only EC artifacts. Then, the frames having only EC artifacts are fully decoded in the EC Video Decoder 65. Full decoding includes at least integer DCT (IDCT) and motion compensation 63, in addition to syntax parsing 62. For obtaining a target extracted frame (e.g. frame n in FIG. 5), the reference frames (e.g. frames n−4, n−3 in FIG. 5), i.e. frames that are directly or indirectly referenced by the target frame, are also fully decoded. The unrelated frames (e.g. frames n−2, n−1 and n+1, . . . , n+5) do not need full decoding. They can be skipped. After the decoding, the pixels of the lost MB are recovered by EC algorithms 64. The resulting target frame after full decoding and error concealment is called Processed Image Sample (PIS). The PIS's are provided to the LEAAM module 204 and the Quality Assessment Module 203a-203c.

Typical Feature Calculation 202

The Typical Feature Calculation module 202 calculates typical features for each frame extracted in the CFE module 201, including so-called effectiveness features or local features, which are calculated at a local level around a lost MB, and condition features, which are calculated at frame level. Effectiveness features are e.g. some or all from the group of spatial motion homogeneity, temporal motion consistence, texture smoothness, and the probabilities of one or more special encoding modes, such as spatial uniformity of motion, temporal uniformity of motion, InterSkipModeRatio and InterDirectModeRatio. The condition features comprise e.g. some or all of Frame Type, ratio of intra-coded MBs or IntraMBsRatio (i.e. number of Intra-coded MBs divided by number of Inter-coded MBs), Motion Index and Texture Index. Condition features are global features of each frame of the training data set. As described in the co-pending patent application [3], the features will be used for emulating a decision process for determining an EC strategy employed by a decoder, i.e. which type of EC method to use.

In one embodiment, a motion index for partially lost P- or B-frames is calculated by averaging the motion vectors lengths of the received MBs of the frame, according to

MotionIndex(n)=average{|mv(n,i,j)|,(i,j)εall received MBs of the frame}

In one embodiment, texture smoothness is obtained from a ratio between DC coefficients and all (DC+AC) coefficients of the MBs that are adjacent to a lost MB. In one embodiment, a texture index is calculated using the texture smoothness value of those MBs that are adjacent to a lost MBs and the lost MBs themselves (the so-called interested MBs), e.g. using the average of the texture smoothness value of the MBs according to

$$TextureIndex ( n ) = \frac{1}{K} {\sum }_{k = 1}^{K} texture smoothness ( n , k )$$

where K is the total number of the interested MBs, and k is the index of an interested MB. The larger the TextureIndex value is, the richer is the texture of the frame. In one embodiment, the texture smoothness is obtained from DCT coefficients of adjacent MBs, e.g. the ratio of DC coefficient energy to the DC+AC coefficient energy, using DCT coefficients of MBs adjacent to a lost MB.

In one embodiment, texture smoothness is calculated according to the following method. For an I-frame that serves as a reference, the texture smoothness of a correctly received MB is calculated using its DCT coefficients according to

$$texturesmoothness ( n , i , j ) = \{ \begin{matrix}0 , & \begin{matrix}if \frac{{( {coeff}_{0} )}^{2}}{{\sum }_{k = 0}^{M - 1} {( {coeff}_{k} )}^{2}} > T , or , \\ {\sum }_{k = 0}^{M - 1} {( {coeff}_{k} )}^{2} = 0\end{matrix} \\ ( {\sum }_{k = 1}^{M - 1} {p}_{k} \times log ( 1 / {p}_{k} ) ) / log ( M - 1 ) , & otherwise\end{matrix} \\ where \\ {p}_{k} = \frac{{( {coeff}_{k} )}^{2}}{{\sum }_{k = 0}^{M - 1} {( {coeff}_{k} )}^{2}} , and if p = O , p \times log ( 1 / p ) = 0 ,$$

k is an index of the DCT coefficients so that k=0 refers to the DC component; M is the size of DCT transform; T is a threshold ranging from 0 to 1 and set empirically according to dataset (e.g. T=0.8). In H.264, the DCT transform can be of size 16×16 or 8×8 or 4×4. If the DCT transform is of size 8×8 (or 4×4), in one method, the above equation is applied to the 4 (or 16) basic DCT transform units of the MB individually, then the texturesmoothness of the MB is the average of the texturesmoothness values of the 4 (or 16) basic DCT transform units. In another method, for 4×4 DCT transform, 4×4 Hadamard transform is applied to the 16 4×4 arrays composed of the same components of the 16 basic 4×4 DCT coefficient units. For 8×8 DCT transform, Haar transform is applied to the 64 2×2 arrays composed of the same components of the 64 8×8 DCT coefficient units. Then 256 coefficients are obtained, no matter what size of the DCT transform is used by the MB. Then the above equation is used to calculate texturesmoothness of the MB.

Then, for an inter predicted frame (P or B frame) with MB loss, the texture smoothness of a correct MB is calculated according to the above-described smoothness calculation equation, and the texture smoothness of a lost MB is calculated as the medium value of those of its neighbor MBs (if exist) as described above, or equals that of the collocated MB of the previous frame. E.g., in one embodiment, if the motion activity of the current MB (e.g. the above defined spatial homogeneity or motion magnitude) equals zero or the MB has no prediction residual (e.g., skip mode, or DCT coefficients of prediction residual equal zero), then the texture smoothness of the MB equals that of the collocated MB in the previous frame. Otherwise, the texture smoothness of a correct MB is calculated according to the above-described smoothness calculation equation, and the texture smoothness of a lost MB is calculated as the medium value of those of its neighbor MBs (if exist), or equals that of the collocated MB of the previous frame. The basic idea behind the equation for texture smoothness is that, if the texture is smooth, most of the energy is concentrated at the DC component of the DCT coefficients; on the other hand, for the high-activity MB, the more textured the MB is, the more uniformly distributed to different AC components of DCT the energy of the MB is.

In one embodiment, the InterSkipModeRatio, which is a probability of inter skip_mode, is calculated using the following method:

$$InterSkipModeRatio = \frac{number of blocks of skip mode}{total number of blocks within the neighboring MBs}$$

Skip mode in H.264 means that no further data is present for the MB in the bitstream.

In one embodiment, the InterDirectModeRatio, which is a probability of inter_direct_mode, is calculated using the following method:

$$InterDirectModeRatio = \frac{number of blocks of direct mode}{total number of blocks within the neighboring MBs}$$

Direct mode in H.264 means that no MV differences or reference indices are present for the MB. The blocks in the previous two equations refer to 4×4_sized_blocks of the neighboring MBs of the lost MB, no matter if the MB is partitioned into smaller blocks or not.

The above two features InterSkipModeRatio and InterDirectModeRatio may be used separately or together, e.g. added-up. Generally, if a MB is predicted using Skip mode or Direct mode in H.264, its motion can be predicted well from the motion of its spatial or temporal neighbor MBs. Therefore, if this type of MB is lost, it can be concealed with less visible artifacts if temporal EC approaches are applied to recover the missing pixels.

Motion homogeneity may refer to spatial motion uniformity, and motion consistence to temporal motion uniformity. In the following, a frame index is denoted as n and the coordinate of a MB in the frame as (i,j). For a lost MB (i,j) in frame n, the condition features for the frame n and the local features for the MB (i,j) are calculated.

For calculating spatial MV homogeneity, in one embodiment, two separate parameters are calculated for spatial uniformity are calculated in x direction and in y direction according to

$${spatialuniformMV}_{x} ( n , i , j ) = standardvariance \{ {mv}_{x} ( n , i - 1 , j - 1 ) , {mv}_{x} ( n , i , j - 1 ) , {mv}_{x} ( n , i + 1 , j - 1 ) , {mv}_{x} ( n , i - 1 , j ) , {mv}_{x} ( n , i + 1 , j ) , {mv}_{x} ( n , i - 1 , j + 1 ) , {mv}_{x} ( n , i , j + 1 ) , {mv}_{x} ( n , i + 1 , j + 1 ) \}$$

$${spatialuniformMV}_{y} ( n , i , j ) = standardvariance \{ {mv}_{y} ( n , i - 1 , j - 1 ) , {mv}_{y} ( n , i , j - 1 ) , {mv}_{y} ( n , i + 1 , j - 1 ) , {mv}_{y} ( n , i - 1 , j ) , {mv}_{y} ( n , i + 1 , j ) , {mv}_{y} ( n , i - 1 , j + 1 ) , {mv}_{y} ( n , i , j + 1 ) , {mv}_{y} ( n , i + 1 , j + 1 ) \}$$

As long as any of the eight MBs around a lost MB (n,i,j) is received or recovered, its motion vector, if existing, is used to calculate the spatial MV homogeneity. If there is no available neighbor MB, the spatial MV uniformity is set to that of the collocated MB in the previous reference frame (i.e. P-frame or reference B-frame in hierarchical H.264 coding).

For H.264 video encoder, one MB may be partitioned into sub-blocks for motion estimation. Thus, in case of an H.264 encoder, the sixteen motion vectors of the 4×4-sized blocks of a MB instead of one motion vector of a MB may be used in the above equation. Each motion vector is normalized by the distance from the current frame to the corresponding reference frame. This practice is applied also in the following calculations that involve the manipulation of motion vectors. The smaller the standard variance of the neighbor MVs is, the more homogeneous is the motion of these MBs. In turn, the lost MB is more probable to be concealed without visible artifacts if a certain type of motion-estimation based temporal EC method is applied. This feature is applicable to lost MBs of inter-predicted frames like P-frames and B-frames. For B-frames, there may be two motion fields, forward and backward. Spatial uniformity is calculated in two directions respectively.

For calculating temporal MV uniformity, in one embodiment, two separate parameters for temporal uniformity are calculated in x direction and in y direction according to

$${temporaluniformMV}_{x} ( n , i , j ) = standardvariance \{ ( {mv}_{x} ( n + 1 , {i}^{′} , {j}^{′} ) - {mv}_{x} ( n - 1 , {i}^{′} , {j}^{′} ) ) \vert ( {i}^{′} , {j}^{′} ) ∈ \{ nine temporally neibor {MB}^{′} s locations \} \}$$

$${temporaluniformMV}_{y} ( n , i , j ) = standardvariance \{ ( {mv}_{y} ( n + 1 , {i}^{′} , {j}^{′} ) - {mv}_{y} ( n - 1 , {i}^{′} , {j}^{′} ) ) \vert ( {i}^{′} , {j}^{′} ) ∈ \{ nine temporally neibor {MB}^{′} s locations \} \}$$

so that the temporal MV uniformity is calculated as the standard variance of the motion difference between the collocated MBs in adjacent frames. The smaller the standard variance is, the more uniform is the motion of these MBs in temporal axis, and in turn, the lost MB is more probable to be concealed without visible artifacts if the motion projection based temporal EC method is applied. This feature is applicable to lost MBs of both Intra frame (e.g. I_frame) and inter-predicted frame (e.g. P_frame and/or B_frame).

If one of the adjacent frames (e.g., frame n+1) is an Intra frame where there is no MV available in the coded bitstream, the MVs of the spatially adjacent MBs (i.e. (n, i±1, j±1)) of the lost MB and those of the temporally adjacent MBs of an inter-predicted frame (i.e. frame n−1 and/or n+1) are used to calculate temporal MV uniformity. That is,

$${temporaluniformMV}_{x} ( n , i , j ) = standardvariance \{ ( {mv}_{x} ( n , {i}^{′} , {j}^{′} ) - {mv}_{x} ( n - 1 , {i}^{′} , {j}^{′} ) ) \vert ( {i}^{′} , {j}^{′} ) ∈ \{ eight neibor {MB}^{′} s locations \} \}$$

$${temporaluniformMV}_{y} ( n , i , j ) = standardvariance \{ ( {mv}_{y} ( n , {i}^{′} , {j}^{′} ) - {mv}_{y} ( n - 1 , {i}^{′} , {j}^{′} ) ) \vert ( {i}^{′} , {j}^{′} ) ∈ \{ eight neibor {MB}^{′} s locations \} \}$$

The MV magnitude is calculated as follows. For a simple zero motion copy based EC scheme, the larger the MV magnitude is, the more probable to be visible is the loss artifact. Therefore, in one embodiment, the average of motion vectors of neighbor MBs and current MB (if not lost) are calculated. That is,

$$averagemagnitudeMV ( n , i , j ) = average \{ \sqrt[2]{{( {mv}_{x} ( n , {i}^{′} , {j}^{′} ) )}^{2} + {( {mv}_{y} ( n , {i}^{′} {j}^{′} ) )}^{2}} \vert ( {i}^{′} , {j}^{′} ) ∈ \{ nine temporally neibor {MB}^{′} s locations \} \}$$

In another embodiment, the magnitude of the median value of the motion vectors of neighbor MBs is used as the motion magnitude of the lost current MB. If the lost current MB has no neighbor MBs, the motion magnitude of the lost current MB is set to that of the collocated MB in the previous frame.

The typical features TF calculated/extracted in the Typical Feature Calculation module 202 can be represented by any values, e.g. numerical or textual (alpha-numerical) values, and they are provided to the LEAAM module 204.

Quality Assessment 203

The Quality Assessment Module 203a-203c can utilize any existing automatic image quality assessment method (or automatic quality assessment model) or subjective image quality assessment method (or subjective quality assessment model). Eg. a full-reference (FR) image quality assessment method known from [1] can be used to obtain the numeric quality score NQS of the extracted frames or pictures, as shown in FIG. 1. In FR image quality assessment methods, the quality of a test image is evaluated by comparing it with a reference image that is assumed to have perfect quality. This method is limited to a situation where the original frames that do not suffer from network transmission impairment are available. In realistic multimedia communication, the original signal is often not available at the client end or the intermediate element device of the network. However, if a training database with no-packet-loss and packet-loss sequences is given, e.g. the training data set defined by ITU-SG12/Q14 for P.NBAMS, the original frame is available, and the solution shown in FIG. 1 is applicable. An advantage of a FR image quality assessment model over a NR image quality assessment model is that it is more accurate and reliable.

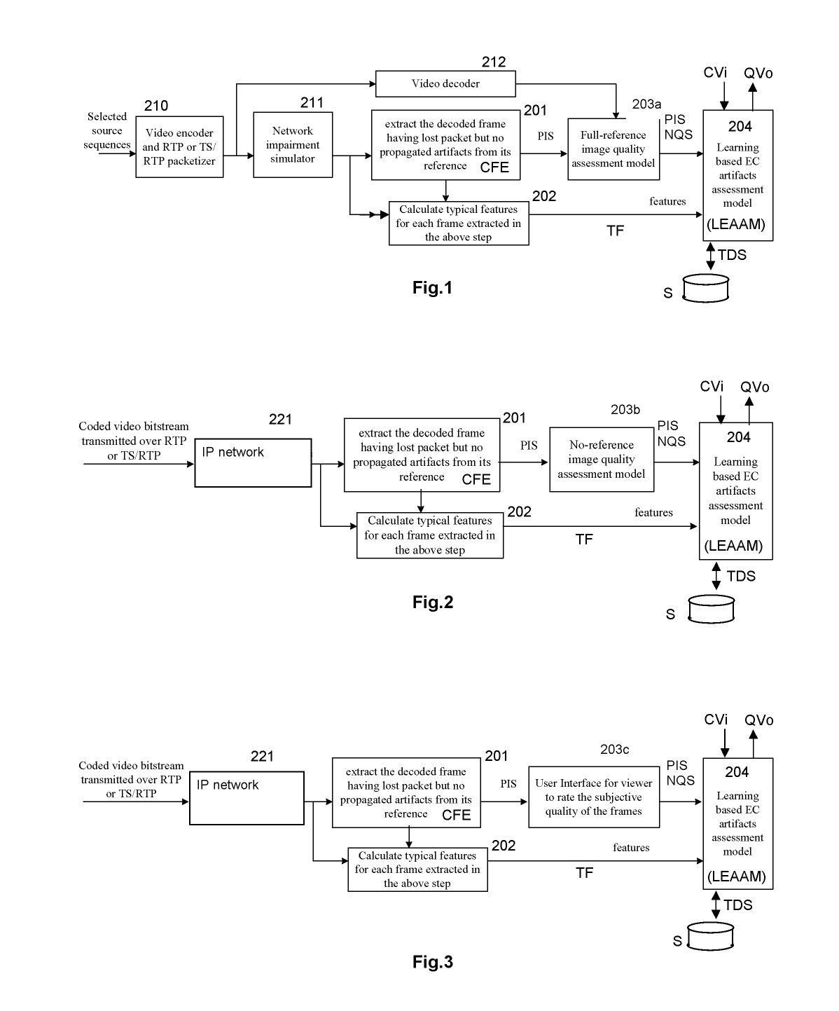

Similar to the embodiment shown in FIG. 1, FIG. 2 shows a no-reference (NR) image quality assessment model, as known e.g. from the literature [2], which is used to obtain the numeric quality score NQS of the extracted frames or pictures. NR measures assess the quality of a received image without having the original image as a reference. This is more consistent with realistic video communication situations, where reference signals are usually not available.

An advantage of the above-described embodiments shown in FIGS. 1 and 2 is that the whole adaptation process is performed automatically and transparent to the end-user. This feature is particularly good for users that are not technically skilled. On the other hand, sometimes a user may want to input his opinion about image quality and let the quality assessment model be finely tuned according to his or her opinion. In the embodiment shown in FIG. 3, the Quality Assessment module 203c allows the viewer to rate the extracted frames directly, e.g. using the single-stimulus Absolute Category Rating defined in ITU-T P.910. This user-interactive solution not only improves the quality assessment accuracy in case of poor performance of the automatic image quality assessment modeling, but also provides an opportunity for personalized quality assessment model tuning.

The VQM model can be embedded e.g. in a set-top box (STB) at a user's home network.

Learning-Based EC Artifacts Assessment Modeling 204

The Learning-based EC Artifacts Assessment Modeling (LEAAM) module 204 receives values of the calculated/extracted features TF from the Typical Features Calculation module 202, and it receives the samples of the training data set TDS, i.e. each PIS and its related numerical quality score (NQS), from the Quality Assessment module 203. The NQS received from the Quality Assessment module 203 serves as reference NQS. In one embodiment, the LEAAM module 204 creates a learning-based EC artifacts assessment model, based on the training data set. In another embodiment, it adapts an existing pre-defined learning-based EC artifacts assessment model based on the training data set. At least in the latter embodiment, model coefficients for a fixed model are determined by the LEAAM module 204. The module generates or adapts parameters or coefficients for an optimized EC artifacts assessment model and stores them in a storage S. It may also store the received samples of the training data set TDS in the storage S, e.g. for later re-evaluation or re-optimization. Further, the received Typical Feature values TF are stored by the LEAAM module.

In one embodiment, the stored data are structured in a data base such that for each PIS its NQS and the values representing its typical features form a data set. The storage may be within the LEAAM module 204 or within a separate storage S.

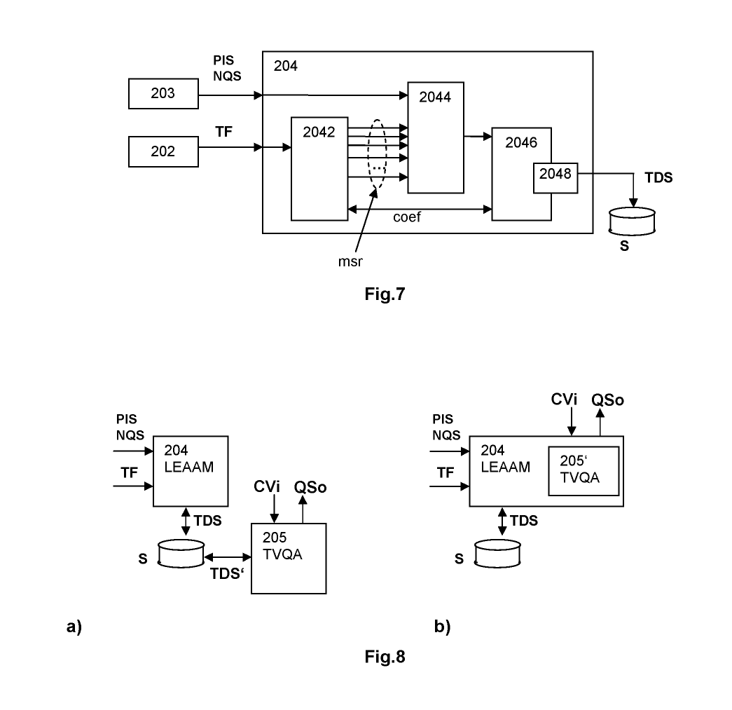

FIG. 7 shows details of an exemplary embodiment of the LEAAM module 204. It has at least a VQM modeling unit 2042 comprising a plurality of different candidate VQM models or a plurality of different candidate coefficient sets for a given VQM model and an Analysis, Matching and Selection unit 2044,2046 for determining from the plurality of VQM models or VQM model coefficient sets an optimal VQM model or VQM model coefficient set that optimally matches the result of the first quality assessment (e.g., Analysis unit 2044 and Matching and Selection unit 2046, or Analysis and Matching unit 2044 and Selection unit 2046). In the VQM modeling unit 2042, the plurality of different candidate VQM models or candidate coefficient sets for a given VQM model are applied to each of the decoded extracted frames, using at least some of the calculated typical features TF. The Analysis, Matching and Selection unit 2044,2046 determines from the plurality of VQM models or VQM model coefficient sets an optimal VQM model or VQM model coefficient set that optimally matches the result of the first quality assessment, wherein for each of the decoded extracted frames the plurality of candidate VQM models is matched with the reference VQM model, and wherein an optimal VQM model or set of VQM model coefficients is obtained.

Further, in one embodiment the LEAAM 204 further comprises an Output unit 2048 that provides the optimal VQM model or set of VQM model coefficients to subsequent modules (not shown) for video quality assessment of target videos.

The model coefficients and/or the optimized model that are obtained in the LEAAM module 204 during at least a first training phase can be applied to an actual video to be assessed. In one embodiment, a device for automatically adapting a Video Quality Model (VQM) to a video decoder and a device for assessing video quality, which uses the VQM, are integrated together in a product, such as a set-top box (STB). In principle, typical features of the actual video to be assessed are calculated and extracted in the same way as for the training data set. The extracted typical features are then compared with the stored training data base as described below, a best-matching condition feature is determined, and parameters or coefficients for the VQM model according to the best-matching condition feature are selected. These parameters or coefficients define, from among the available trained VQM models, an optimal VQM model for the actual video to be assessed. The optimal VQM model is applied to the actual video to be assessed in a Target Video Quality Assessment (TVQA) module 205, as shown in FIG. 8. The TVQA module, which receives the actual video to be assessed through a coded video input CVi and provides a quality score value QSo at its output, accesses the training data sets TDS' in the storage S.

FIG. 8 shows in two exemplary embodiments how the optimized model is applied to the actual video to be assessed. In FIG. 8 a), a Target Video Quality Assessment (TVQA) module 205 is separate from the LEAAM 204 module, but it can access from its storage S the training data sets TDS′, in particular it can read the data sets of typical features and corresponding model parameters. In FIG. 8 b), the TVQA module 205′ is integrated as a submodule in the LEAAM module 204, so that no separate access to the storage S is required for TVQA module 205. In this embodiment, the LEAAM module 204 also applies the optimized EC artifacts assessment model to the actual video to be assessed.

In the LEAAM module 204, statistic learning methods may be used to implement the adaptive EC artifacts assessment model. E.g., the LEAAM module may implement the method disclosed in the co-pending patent application [3], i.e. using the above-mentioned condition features to determine which type of EC method to use, and using the local features as parameters of the determined type of EC method. In one embodiment, all the condition features and local features are put into an artificial neural network (ANN) for obtaining the optimal model. Another embodiment, which is an example implementation of this part of the LEAAM module 204, is described in the following.

FIG. 9 shows a flow-chart 90 of a method for generating a training dataset for EC artifacts assessment. The method comprises steps of extracting 91 one or more concealed frames from a training video stream, decoding 94 the extracted frames and performing Error Concealment, and performing a first quality assessment 95 of the decoded extracted frames using a Reference VQM model. Further steps comprise determining 92 typical features of the extracted frames and performing a second quality assessment 93 of the extracted frames by using, for each of the decoded extracted frames, a plurality of different candidate VQM models (or a plurality of different candidate coefficient sets for at least one given VQM model), wherein at least some of the calculated typical features are used. Then, from the plurality of VQM models or VQM model coefficient sets a best VQM model, or best VQM model coefficient set, is determined 96 that optimally matches the result of the first quality assessment, wherein, for each of the decoded extracted frames 961,963, the results of the plurality of candidate VQM models are matched 962 with the result (NQS) of the reference VQM model. Thus, an optimal VQM model or set of VQM model coefficients is obtained. Finally, the optimal VQM model or set of VQM model coefficients is provided 97 for video quality assessment of target videos.

For condition feature Frame Type, the calculation of the EC artifacts level is

$$ECartifactsLevel = \{ \begin{matrix}\begin{matrix}{a}_{1}^{*} motionUniformity + \\ {b}_{1}^{*} textureSmoothness + \\ {c}_{1}^{*} InterSkipModeRatio + \\ {d}_{1}^{*} InterDirectModeRatio\end{matrix} & ( if Frame Type is Intra ) \\ \begin{matrix}{e}_{1}^{*} motionUniformity + \\ {f}_{1}^{*} textureSmoothness + \\ {g}_{1}^{*} InterSkipModeRatio + \\ {h}_{1}^{*} InterDirectModeRatio\end{matrix} & ( if Frame Type is Inter )\end{matrix} \qquad ( 1 )$$

For condition feature IntraMBsRatio, the calculation of the EC artifacts level is

$$ECartifactsLevel = \{ \begin{matrix}\begin{matrix}{a}_{2}^{*} motionUniformity + \\ {b}_{2}^{*} textureSmoothness + \\ {c}_{2}^{*} InterSkipModeRatio + \\ {d}_{2}^{*} InterDirectModeRatio\end{matrix} & ( if IntraMBsRatio \geq T 1 ) \\ \begin{matrix}{e}_{2}^{*} motionUniformity + \\ {f}_{2}^{*} textureSmoothness + \\ {g}_{2}^{*} InterSkipModeRatio + \\ {h}_{2}^{*} InterDirectModeRatio\end{matrix} & ( if IntraMBsRatio < T 1 )\end{matrix} \qquad ( 2 )$$

For the combination of the condition features MotionIndex and TextureIndex, the calculation of the EC artifacts level is

$$ECartifactsLevel = \{ \begin{matrix}\begin{matrix}{a}_{3}^{*} motionUniformity + \\ {b}_{3}^{*} textureSmoothness + \\ {c}_{3}^{*} InterSkipModeRatio + \\ {d}_{3}^{*} InterDirectModeRatio\end{matrix} & ( if {k}^{*} MotionIndex + TextureIndex \geq T 2 ) \\ \begin{matrix}{e}_{3}^{*} motionUniformity + \\ {f}_{3}^{*} textureSmoothness + \\ {g}_{3}^{*} InterSkipModeRatio + \\ {h}_{3}^{*} InterDirectModeRatio\end{matrix} & ( if {k}^{*} MotionIndex + TextureIndex < T 2 )\end{matrix} \qquad ( 3 )$$

T1 and T2 are thresholds that can be determined e.g. by adaptive learning. An advantage of utilizing the piece-wise function form in Eqs. (1-3) is that the decoder may adopt a more advanced EC strategy by choosing a type of EC approach (i.e., spatial EC or temporal EC) according to certain conditions for each portion. If the decoder only adopts one type of EC approach by setting a=e, b=f, c=g, and d=h, the piece-wise function also works, but is less adaptive and therefore may have slightly worse results.

For example, the above-mentioned effectiveness features motionUniformity, texture Smoothness, InterSkipModeRatio and InterDirectModeRatio and the above-mentioned condition features Frame Type, IntraMBsRatio, Motion index and Texture Index are calculated as numerical values in the Typical Feature Calculation module 202 and stored in storage S for each of the training images (i.e. PIS's), and for each video frame to be assessed. For training the VQM model, the feature values are stored together with the quality score NQS of the training image, which is obtained in the Quality Assessment model 203. For assessing the quality of a target video frame, the calculations according to equations (1)-(3) are performed using the features of the target video frame, with parameters a₁, . . . , h₃ obtained during the model training.

The calculation of a texture index may be based on any known texture analysis method, e.g. a comparing a DC coefficient and/or selected AC coefficients with thresholds.

In principle it is sufficient to use any two or more of the condition (i.e. global) features, and any two or more of the effectiveness (i.e. local) features. The more features are used, the better will be the result.

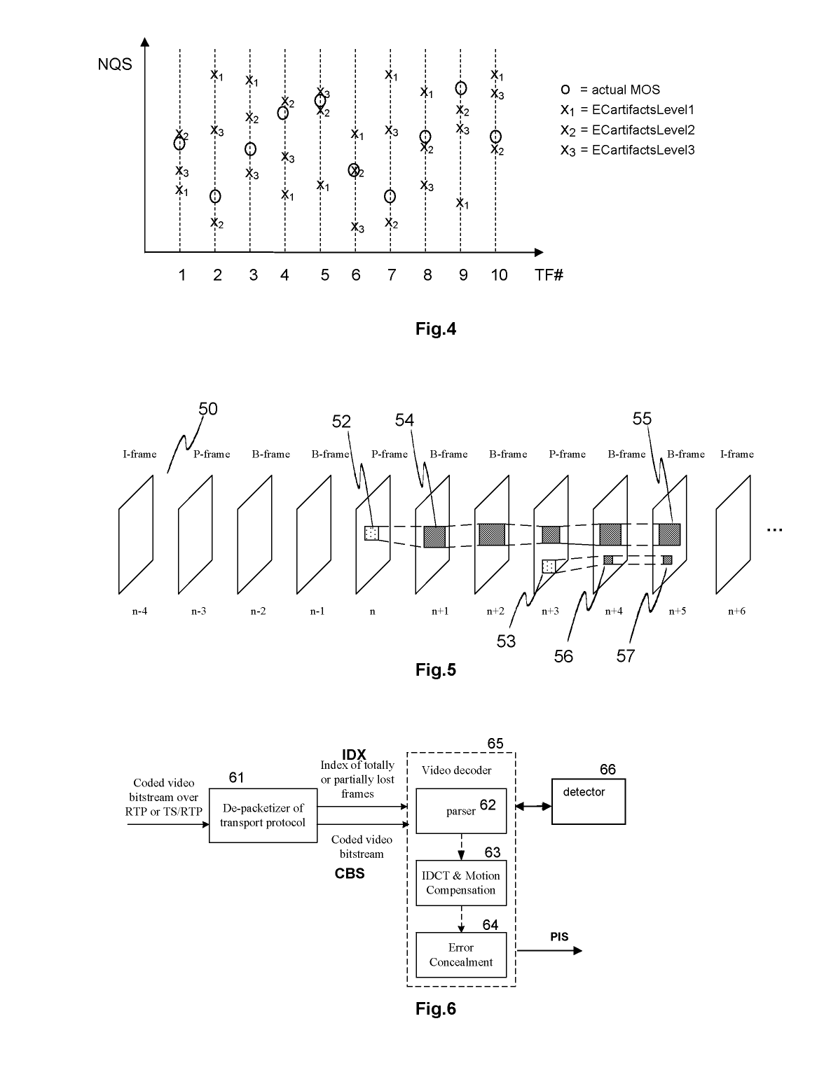

The selection according to the correlation (PC coefficient value) can be summarized as in FIG. 4, Tab.1 and Tab.2. FIG. 4 shows in a diagram exemplarily the principle of adaptive selection of an optimal VQM model when performing the second quality assessment 93 of the extracted frames by using, for each of the decoded extracted frames, a plurality of different candidate VQM models (or equivalently, a plurality of different candidate coefficient sets for at least one given VQM model). On the horizontal axis are the training frame numbers TF#, while on the vertical axis there are the numeric quality score values NQS obtained by the different VQM models. For each of the training frames, a single reference quality value as obtained from the reference VQM model (denoted “0”) and a plurality of candidate quality values x₁, . . . , x₃ as obtained from the various candidate VQM models, is shown. For example, using the above-mentioned condition features, x₁ may be the quality score as obtained from the Frame Type condition feature, x₂ the quality score as obtained from the IntraMBsRatio condition feature, and x₃ the quality score as obtained from the MotionIndex-TextureIndex condition feature. In one embodiment, the LEAAM module 204 varies some or all coefficients a₁, . . . , h₃, T₁, T₂, k of the above equations during the training or adaptive learning process, which results in a shift of the candidate quality values x₁, . . . , x₃ in FIG. 4. In another embodiment, some or all coefficients of each VQMM are pre-defined, and need not be optimized. The LEAAM module 204 determines a correlation coefficient for each of the VQM models, e.g. one correlation coefficient v₁ between the candidate quality values x₁ of a first candidate and the reference quality values o, one correlation coefficient v₂ between the candidate quality values x₂ of a second candidate and the reference quality values o, etc., and in one embodiment may further optimize the correlation by varying the coefficients a₁, . . . , h₃, T₁, T₂, k of some or each candidate VQM model.

A correlation is optimized if the correlation coefficient v is at its maximum, so that the results of the optimal candidate VQMM and the reference quality values converge as much as possible. In other words, the optimal candidate VQMM emulates the actual behavior of the target video decoder and EC method best. Tab.1 shows exemplary values of the first three training frames of FIG. 4. In this embodiment, for each candidate VQM the coefficients are varied, which leads to numerical quality score values that vary within a range for each training frame TF#. The coefficients are varied such that each candidate VQM matches optimally the reference numeric quality score value (Ref.NQS). Tab.1 shows the numeric quality score value that are obtained with optimized coefficients in “( )”.

TABLE 1
Variation and optimization of VQM coefficients

| TF# | Ref. NQS | NQS of Cand. VQM₁ | NQS of Cand. VQM₂ | NQS of Cand. VQM₃ |
|---|---|---|---|---|
| 1 | 5.0 | 2.2 . . . 2.8 (2.7) | 4.7 . . . 5.2 (5.1) | 3.1 . . . 3.5 (3.3) |
| 2 | 2.3 | 8.1 . . . 8.4 (8.2) | 1.6 . . . 1.9 (1.9) | 5.7 . . . 6.2 (5.9) |
| 3 | 4.7 | 7.7 . . . 8.0 (7.8) | 6.5 . . . 6.8 (6.5) | 3.1 . . . 3.5 (3.4) |
| . . . | . . . | . . . | . . . | . . . |

In another embodiment, some or all coefficients are pre-defined. Then, a correlation between each candidate numeric quality score value and the reference numeric quality score value is calculated by regression analysis. Tab.2 shows an intermediate result within the LEAAM module 204, comprising a plurality of correlation values v₁, v₂, v₃ and related optimized coefficients of three candidate VQM models, namely Frame Type, IntraMBsRatio and kxMotionIndex+TextureIndex. E.g. if v₁>v₂ and v₁>v₃, then Frame Type is the optimal condition feature and the coefficients a₁, . . . , d₁ or e₁, . . . , h₁ are used for the model, depending on the current condition feature (in this case the frame type).

TABLE 2
Derivation of artifacts modeling based on regression analysis

| | | Optimal | |
|---|---|---|---|
| Condition feature | Conditions | coefficients | PC |
| FrameType | Intra coded frame | {a₁, b₁, c₁, d₁} | v₁ |
| | Inter coded frame | {e₁, f₁, g₁, h₁} | |
| IntraMBsRatio | ≧T₁ | {a₂, b₂, c₂, d₂} | v₂ |
| | <T₁ | {e₂, f₂, g₂, h₂} | |
| k × MotionIndex + | ≧T₂ | {a₃, b₃, c₃, d₃} | v₃ |
| TextureIndex | <T₂ | {e₃, f₃, g₃, h₃} | |

Thus, the LEAAM module 204 determines from the plurality of VQM models (or VQM model coefficient sets) a best VQM model (or best VQM model coefficient set) that optimally matches the result of the first quality assessment, wherein, for each of the decoded extracted frames, the results of the plurality of candidate VQM models are matched with the result of the reference VQM model, and wherein an optimal VQM model (or set of VQM model coefficients) is obtained.

Returning to FIG. 9, the second quality assessment 93 comprises steps of enumerating 91 the possible combinations of the condition features and local features, e.g. those of equations (1)-(3) above, in a feature combination module. These features can also be complemented by other, further features and their relationships. In one embodiment, a correlation module performs multiple regression analysis for each of the enumerated combinations (e.g. equations (1)-(3)) 92 in order to fit the equation on the training data set and get the coefficient set that fits best, e.g. by calculating the corresponding Pearson Correlation value v1, v2, v3. In one embodiment, the selection module (within the second quality assessment 93) selects the best fitting equation from the equations (1)-(3), being the one that results in the highest PC value, as an optimal model (or model coefficient set, respectively).

The extracted frames are decoded and Error Concealment is performed 94. A first quality assessment 95 of the decoded extracted frames is performed, using a Reference Video Quality Measuring model. A second quality assessment 93 of the extracted frames is performed as described above, i.e. by using, for each of the decoded extracted frames, a plurality of different candidate Video Quality Measuring models or a plurality of different candidate coefficient sets for at least one given Video Quality Measuring model, wherein at least some of the calculated typical features are used.

From the plurality of Video Quality Measuring models or Video Quality Measuring model coefficient sets, a best Video Quality Measuring model or best Video Quality Measuring model coefficient set, is determined 96 that optimally matches the result of the first quality assessment, wherein, for each of the decoded extracted frames, the results of the plurality of candidate Video Quality Measuring models are matched 962 with the result (i.e. NQS) of the reference Video Quality Measuring model and wherein an optimal Video Quality Measuring model or set of Video Quality Measuring model coefficients is obtained, as also shown in FIG. 9 and described below. Finally, the optimal Video Quality Measuring model or set of Video Quality Measuring model coefficients is provided 97 for video quality assessment of target videos.

Details of embodiments of the second quality assessment module 93 and the determining module 96 for determining the best Video Quality Measuring model or best Video Quality Measuring model coefficient set, i.e. the one that optimally matches the result of the first quality assessment, are also shown in FIG. 9. This embodiment of the second quality assessment module 93 comprises a selection unit 931 for selecting a current candidate Video Quality Measuring models or a current candidate coefficient set for a given Video Quality Measuring model, an application module 932 for applying the current candidate Video Quality Measuring model or current candidate coefficient set to each of the decoded extracted frames, using at least some of the calculated typical features, comparing 932 the result with previous results and storing the best one, and determining 933 if more candidate VQMM or candidate coefficient sets are available. In the depicted embodiment of the determining module 96 for determining the best Video Quality Measuring model or best Video Quality Measuring model coefficient set, the module comprises selection unit 961 for selecting from the plurality of VQM models or VQM model coefficient sets a current VQM model or VQM model coefficient set, a matching and selection module 962 for matching (for each of the decoded extracted frames) the current candidate VQM model with the reference VQM model, selecting an optimal VQM model or set of VQM model coefficients (either the best previous or the current) and storing it, and determining unit 962 for determining if more VQM models or VQM model coefficient sets exist.

FIG. 14 shows an exemplary embodiment of a LEAAM module, comprising a Feature Combination module 141, an EC module 144, a first quality assessment module 145, a correlation module 142, a second quality assessment module 143 comprising a selection module, a determining module 149 that comprises frame selection units 1461,1463 and a matching unit 1462 and determines, for each of the decoded extracted frames, a result of the first quality assessment that optimally matches the results of the plurality of candidate Video Quality Measuring models.

The feature combination module 141 enumerates the possible combinations of the condition features and local features, e.g. those of equations (1)-(3) above. These can also be complemented by other, further features and their relationships. In one embodiment, the correlation module 142 performs multiple regression analysis for each of the enumerated combinations (e.g. equations (1)-(3)) in order to fit the equation on the training data set and get the coefficient set that fits best, e.g. by calculating the corresponding Pearson Correlation value v1, v2, v3. In one embodiment, the selection module (within second quality assessment module 143) selects the best fitting equation from the equations (1)-(3), being the one that results in the highest PC value, as an optimal model (or model coefficient set, respectively). The extracted frames are decoded and Error Concealment is performed 144. In the first quality assessment module 145, a first quality assessment of the decoded extracted frames is performed, using a Reference Video Quality Measuring model. In the second quality assessment module 143, a second quality assessment of the extracted frames is performed as described above, i.e. by using, for each of the decoded extracted frames, a plurality of different candidate Video Quality Measuring models or a plurality of different candidate coefficient sets for at least one given Video Quality Measuring model, wherein at least some of the calculated typical features are used.

From the plurality of Video Quality Measuring models or Video Quality Measuring model coefficient sets, a best Video Quality Measuring model or best Video Quality Measuring model coefficient set, is determined 96 that optimally matches the result of the first quality assessment, wherein, for each of the decoded extracted frames, the results of the plurality of candidate Video Quality Measuring models are matched 962 with the result (i.e. NQS) of the reference Video Quality Measuring model and wherein an optimal Video Quality Measuring model or set of Video Quality Measuring model coefficients is obtained, as also shown in FIG. 9 and described below. Finally, the optimal Video Quality Measuring model or set of Video Quality Measuring model coefficients is provided 97 for video quality assessment of target videos.

Details of embodiments of the second quality assessment module 143 and the determining module 146 for determining the best Video Quality Measuring model or best Video Quality Measuring model coefficient set, i.e. the one that optimally matches the result of the first quality assessment, are also shown in FIG. 14.

This embodiment of the second quality assessment module 143 comprises a selection unit 1431 for selecting a current candidate Video Quality Measuring models or a current candidate coefficient set for a given Video Quality Measuring model, an application module 1432 for applying the current candidate Video Quality Measuring model or current candidate coefficient set to each of the decoded extracted frames, using at least some of the calculated typical features, comparing 1432 the result with previous results and storing the best one, and determining 1433 if more candidate VQMM or candidate coefficient sets are available. In the depicted embodiment of the determining module 146 for determining the best Video Quality Measuring model or best Video Quality Measuring model coefficient set, the module comprises selection unit 1461 for selecting from the plurality of VQM models or VQM model coefficient sets a current VQM model or VQM model coefficient set, a matching and selection module 1462 for matching (for each of the decoded extracted frames) the current candidate VQM model with the reference VQM model, selecting an optimal VQM model or set of VQM model coefficients (either the best previous or the current) and storing it, and determining unit 1462 for determining if more VQM models or VQM model coefficient sets exist.

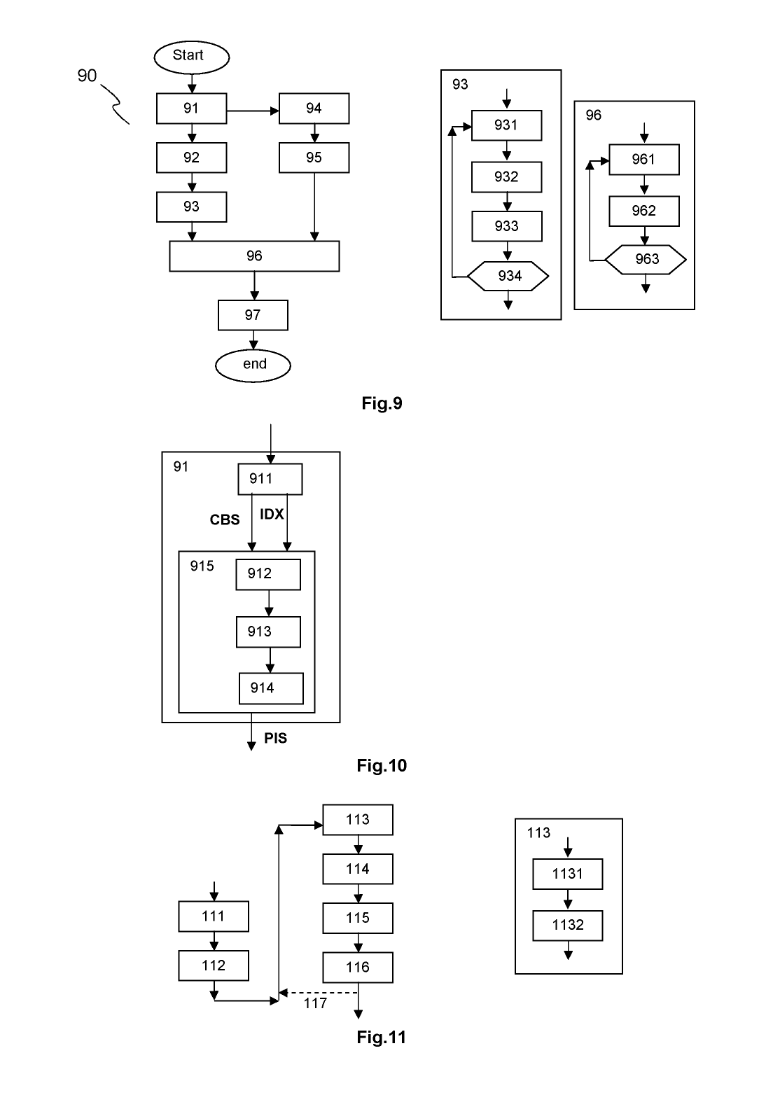

FIG. 10 shows a flow-chart of one embodiment of the method for measuring a video quality. In this embodiment, the step of extracting 91 concealed frames from the training video stream comprises steps of de-packetizing 911 the stream according to a transport protocol, wherein the coded bitstream (CBS) and one or more indices (IDX) of concealed frames are obtained, and emulating a decoder 915. The emulating a decoder comprises parsing 912 the coded bitstream, wherein among the one or more concealed frames at least one frame is detected in which at least one macroblock is missing and in which all inter coded macroblocks are predicted from non-concealed reference macroblocks, decoding 913 the at least one detected frame, wherein also frames that are required for prediction of the detected frame are decoded, and performing 914 Error Concealment on the detected frame, wherein the Error Concealment of the target decoder is used and a PIS is obtained.

In one embodiment, the LEAAM module 204 uses a single fixed template model and determines the model coefficients that optimize the template model. In one embodiment, the LEAAM module 204 can select one of a plurality of template models. In one embodiment, the template model is a default model that can also be used without being optimized; however, the optimization improves the model.

An advantage of the described extraction/calculation of global condition features from an image of the training data set and the local effectiveness features is that they make the model more sensitive to channel artifacts than to compression artifacts. Thus, the model focuses on channel artifacts and depends less on different levels of compression errors. The calculated EC effectiveness level is provided as an estimated visible artifacts level of video quality.

Advantageously, the used features are based on data that can be extracted from the coded video at bitstream-level, i.e. without decoding the bitstream to the pixel domain.

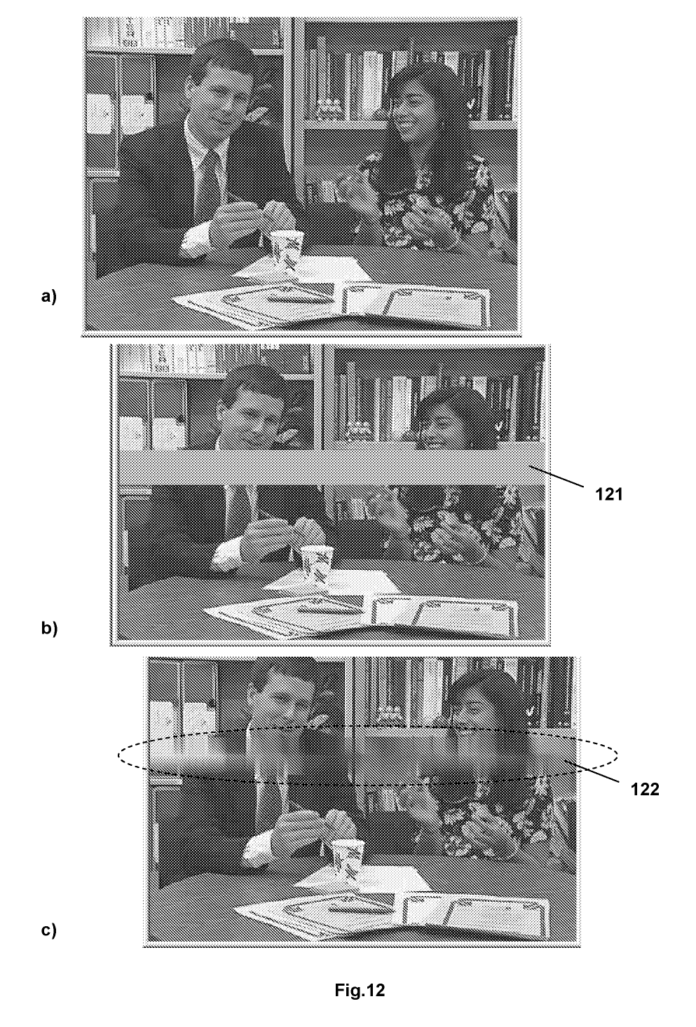

In FIG. 12, different visible artifacts are shown that are produced by different EC strategies employed at the decoder side. FIG. 12 a) shows the original image. During network impairment, two rows of macroblocks (MBs) are lost e.g. in the 165^{th} frame of a compressed video sequence. In poor decoders, no EC strategy is implemented at all. This results in lost data, such as the area 121 that is grey in FIG. 12 b). In this case, the target frame after full decoding is the PIS by regarding the “no error concealment” as a special case of error concealment strategy. If the JVT JM reference decoder or the ffmpeg decoder respectively is used to decode the impaired bitstream, the perceptual quality of the decoded frame is better, as shown in FIG. 12 c). The different visibility of EC artifacts results from the different EC strategy implemented in the respective decoders; the perceptual EC artifacts level depends heavily on video content features and the video compression techniques used. As described above, the corresponding EC strategy is performed in the Concealed Frame Extraction module 201 of the present invention.

In one embodiment, a flow-chart of a method for adapting a VQM to a given decoding and EC method is shown in FIG. 11. The method is capable of automatically adapting to a video decoder being one out of a plurality of different decoders and performing EC, and comprises steps of extracting 111 concealed decoded frames, calculating 112 current typical features TF of the extracted frames, performing a first quality assessment 113 of the extracted concealed and decoded frames, wherein a quality value NQS of the extracted concealed frames is obtained 1131 and a quality value NQS of the decoded frames is obtained 1132, associating 114 the quality value NQS of the extracted concealed and decoded frames with the calculated typical features TF of the extracted frames, selecting 115 and storing 116 at least the quality value NQS and its associated typical features TF as a training data set for EC artifact assessment and repeating 117 the steps 113-116. Finally, the training data set is stored.

The typical features TF of the extracted frames can be calculated before their full decoding and EC. In one embodiment, the typical features TF of the extracted frames are calculated from un-decoded extracted frames. In another embodiment, the typical features TF are calculated from partially decoded extracted frames. In one embodiment, the partial decoding reveals at least one of Frame Type, IntraMBsRatio, MotionIndex and TextureIndex, as well as motion Uniformity, textureSmoothness, InterSkipModeRatio and InterDirectModeRatio, according to the above definitions.

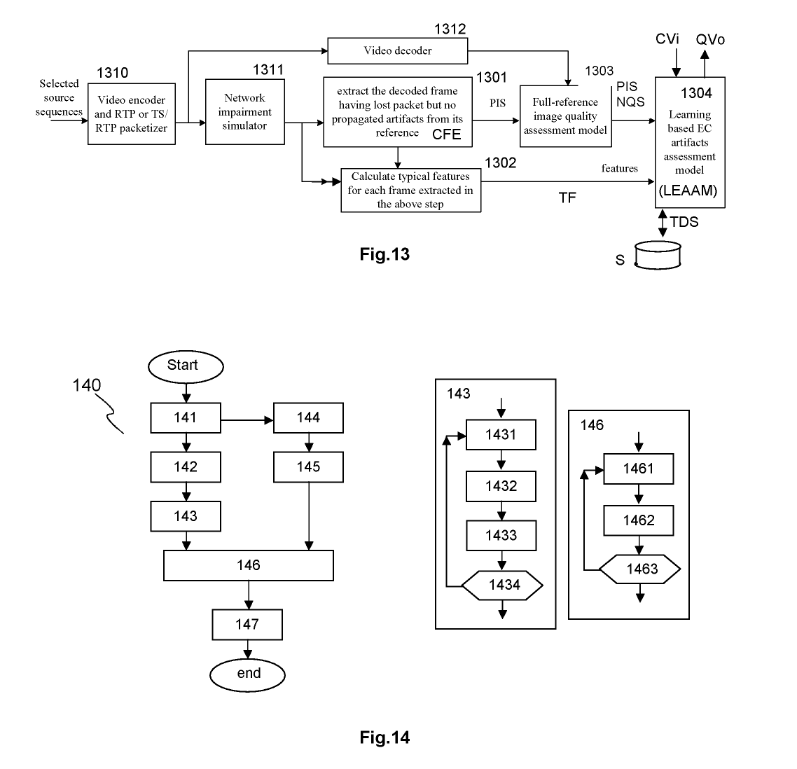

Further, in one embodiment as shown in FIG. 13, a method for generating a training dataset for adaptive video quality measurement of target videos decoded by a video decoder, the video decoder comprising error concealment, comprises steps of selecting 1301 training data frames of a predefined type from a plurality of provided training data frames,

analyzing 1302 predefined typical features of the selected training data frames, decoding 65 the training data frames using the video decoder, wherein the decoding comprises at least error concealment 64,

measuring or estimating a reference video quality metric (measure) for each of the decoded and error concealed training data frames using a reference video quality measurement 1303,

for each of the selected training data frames, calculating 1304 from the analyzed typical features a plurality of candidate video quality measurement measures, wherein for each of the selected training data frames a plurality of different predefined candidate video quality measurement models or candidate sets of video quality measurement coefficients of a given video quality measurement model are used,

storing, for each of the selected training data frames, the plurality of candidate video quality measurement models or candidate sets of video quality measurement coefficients and their calculated candidate video quality measurement measures x₁, . . . , x₃,

determining, from the plurality of candidate video quality measurement models or candidate sets of video quality measurement coefficients, an optimal video quality measurement model or optimal set of video quality measurement coefficients in an adaptive learning process 1304, wherein for each of the selected training data frames the stored candidate video quality measurement measures are compared and matched with the reference video quality measure and a best-matching candidate video quality measurement measure is determined, and

storing the video quality measurement coefficients or the video quality measurement model of the optimal video quality measurement measure.

An advantage of the present invention is that it enables the VQM model to learn the EC effects without having to know and emulate the EC strategy employed in decoder. Therefore, the VQM model can automatically adapt to various real-world decoder implementations.

VQM is used herein as an acronym for Video Quality Modeling, Video Quality Measurement or Video Quality Measuring, which are considered as equivalents.

While there has been shown, described, and pointed out fundamental novel features of the present invention as applied to preferred embodiments thereof, it will be understood that various omissions and substitutions and changes in the apparatus and method described, in the form and details of the devices disclosed, and in their operation, may be made by those skilled in the art without departing from the present invention. Although all candidate VQM models in the described embodiments use the same set of typical features, there may exist cases where one or more of the candidate VQM models use only less or different typical features than other candidate VQM models.

Further, it is expressly intended that all combinations of those elements that perform substantially the same function in substantially the same way to achieve the same results are within the scope of the invention. Substitutions of elements from one described embodiment to another are also fully intended and contemplated. It will be understood that the present invention has been described purely by way of example, and modifications of detail can be made without departing from the scope of the invention.

Each feature disclosed in the description and (where appropriate) the claims and drawings may be provided independently or in any appropriate combination. Features may, where appropriate be implemented in hardware, software, or a combination of the two. Reference numerals appearing in the claims are by way of illustration only and shall have no limiting effect on the scope of the claims.

### CITED REFERENCES

[1] U. Engelke, “Perceptual quality metric design for wireless image and video communication”, Blekinge Institute of Technology Ph.D dissertation, 2008
[2] H. Rui, C. Li, and S. Qiu, “Evaluation of packet loss impairment on streaming video”, Journal of Zhejiang University—Science A, Vol. 7, pp. 131-136, Jan. 2006
[3] “Method and device for estimating video quality on bitstream level”, N. Liao, X. Gu, Z. Chen, K. Xie, co-pending International Patent Application PCT/CN2011/000832, International Filing date May 12, 2011 (Attorney Docket Ref. PA110009)

1-19. (canceled)

20. A method for generating a training dataset for Error Concealment artifacts assessment, comprising steps of
extracting one or more concealed frames from a training video stream;
determining typical features of the extracted frames;
decoding the extracted frames and performing Error Concealment;
performing a first quality assessment of the decoded extracted frames using a Reference Video Quality Measuring model;
performing a second quality assessment of the extracted frames by using, for each of the decoded extracted frames, a plurality of different candidate Video Quality Measuring models or a plurality of different candidate coefficient sets for at least one given Video Quality Measuring model, wherein at least some of the calculated typical features are used;
determining from the plurality of Video Quality Measuring models or Video Quality Measuring model coefficient sets a best Video Quality Measuring model, or best Video Quality Measuring model coefficient set, that optimally matches the result of the first quality assessment, wherein, for each of the decoded extracted frames, the results of the plurality of candidate Video Quality Measuring models are matched with the result of the reference Video Quality Measuring model and wherein an optimal Video Quality Measuring model or set of Video Quality Measuring model coefficients is obtained; and
providing the optimal Video Quality Measuring model or set of Video Quality Measuring model coefficients for video quality assessment of target videos.

21. The method according to claim 20, wherein in the step of extracting one or more concealed frames only frames are extracted in which at least one macroblock is missing, and in which all inter coded macroblocks are predicted from non-concealed reference macroblocks.

22. Method according to claim 21, wherein the step of extracting concealed frames from the training video stream comprises steps of
a. de-packetizing the stream according to a transport protocol, wherein the coded bitstream and one or more indices of concealed frames are obtained;
b. parsing the coded bitstream, wherein among the one or more concealed frames at least one frame is detected in which at least one macroblock is missing and in which all inter coded macroblocks are predicted from non-concealed reference macroblocks;
c. decoding the at least one detected frame, wherein also frames that are required for prediction of the detected frame are decoded; and
d. performing Error Concealment on the detected frame, wherein the Error Concealment of the target decoder is used.

23. The method according to claim 20, wherein in the step of determining typical features, two or more global features on frame level and two or more local features around a lost macroblock are determined or calculated, the global features being used as condition features for selecting a Video Quality Measuring model and the local features being used for adapting the selected Video Quality Measuring model.

24. Method according to claim 23, wherein a Video Quality Measuring model is defined by a piecewise linear function, and the global features are used for determining which piece of the piecewise linear function is to be used.

25. Method according to claim 23, wherein the global features used as condition features for selecting a Video Quality Measuring model comprise two or more of
Frame Type,
IntraMBsRatio being a ratio of intra-coded macroblocks,
MotionIndex and TextureIndex.

26. Method according to claim 23, wherein the local features are used as effectiveness features and comprise two or more of
motionUniformity comprising spatial uniformity of motion and temporal uniformity of motion,
texture smoothness as obtained from a ratio between DC coefficients and DC+AC coefficients of macroblocks adjacent to a lost macroblock,
InterSkipModeRatio being a ratio of macroblocks using skip mode, and
InterDirectModeRatio being a ratio of macroblocks using direct mode.

27. Method according to claim 21, wherein the reference Video Quality Measuring model is a full-reference Video Quality Measuring model.

28. Method according to claim 21, wherein the reference Video Quality Measuring model is a no-reference Video Quality Measuring model.

29. Method according to claim 21, wherein a user can determine or adjust the reference Video Quality Measuring model through a user interface.

30. Method according to claim 21, wherein in the step of determining a best Video Quality Measuring model, the matching comprises determining for each of the extracted frames a correlation v₁, . . . , v₃ between the plurality of candidate Video Quality Measuring models and the result of the reference Video Quality Measuring model.

31. A Video Quality Measuring method for measuring or estimating video quality of a target video, wherein the Video Quality Measuring method comprises an adaptive Error Concealment artifact assessment model trained by the generated training dataset generated according to claim 21.

32. A device for generating a training dataset for Error Concealment artifacts assessment in a Video Quality Measuring device, comprising
a. a Concealed Frame Extraction module adapted for extracting one or more concealed frames from a training video stream, decoding the extracted frames and performing Error Concealment;
b. a Typical Feature Calculation unit adapted for calculating typical features of the extracted frames;
c. a Reference Video Quality Assessment unit adapted for performing a first quality assessment of the decoded extracted frames by using a reference Video Quality Measuring model; and
d. a Learning-based Error Concealment Artifacts Assessment unit for performing a second quality assessment of the extracted frames, the Learning-based Error Concealment Artifacts Assessment Module having
e. a plurality of different candidate Video Quality Measuring models or a plurality of different candidate coefficient sets for a given Video Quality Measuring model, wherein the plurality of different candidate Video Quality Measuring models or candidate coefficient sets for a given Video Quality Measuring model are applied to each of the decoded extracted frames and use at least some of the calculated typical features; and
f. an Analysis, Matching and Selection unit adapted for determining from the plurality of Video Quality Measuring models or Video Quality Measuring model coefficient sets an optimal Video Quality Measuring model or Video Quality Measuring model coefficient set that optimally matches the result of the first quality assessment, wherein for each of the decoded extracted frames the plurality of candidate Video Quality Measuring models is matched with the reference Video Quality Measuring model and wherein an optimal Video Quality Measuring model or set of Video Quality Measuring model coefficients is obtained.

33. Device according to claim 32, wherein the Learning-based Error Concealment Artifacts Assessment Module further comprises an Output unit adapted for providing the optimal Video Quality Measuring model or set of Video Quality Measuring model coefficients for video quality assessment of target videos.

34. Device according to claim 32, wherein in the Concealed Frame Extraction module one or more decoded frames are extracted that have lost at least one macroblock or packet and that are predicted from one or more prediction references and have no propagated artifacts from the prediction references.

35. Device for automatically adapting a Video Quality Measuring Model to a video decoder, the device comprising
a. a Frame Extraction module for extracting one or more frames from a packetized video bitstream;
b. a Typical Features Calculation module, receiving input from the Frames Extraction module, for performing an analysis of the one or more extracted frames and for calculating typical features of the extracted one or more frames, based on said analysis;
c. a Quality Assessment module, receiving input from the Concealed Frames Extraction module, for performing a first quality assessment of the one or more extracted frames; and
d. an Error Concealment Artifacts Assessment Module for performing adaptive Error Concealment artifact assessment, comprising a Video Quality measuring device being trained by a training dataset for Error Concealment artifacts assessment that is generated by the device according to claim 32.

36. Device according to claim 35, wherein the Typical Features Calculation module determines two or more of a motion uniformity, texture smoothness, a ratio of macroblocks using skip mode in inter coded frames and a ratio of macroblocks using direct mode in inter coded frames.

37. Device according to claim 35, wherein the Error Concealment Artifacts Assessment Module comprises a processor for
a. determining in frames or packets of a coded video input two or more features of
b. a motion uniformity;
c. a texture smoothness
d. a ratio of macroblocks using skip mode in inter coded frames; and
e. a ratio of macroblocks using direct mode in inter coded frames; and for
f. determining a correlation coefficient between the two or more features determined in the frames or packets of the coded video input and the corresponding features determined in the Typical Features Calculation module; and
g. performing a video quality assessment on the coded video input, wherein a video quality score according to the determined correlation coefficient is determined.

38. Device according to claim 35, wherein the Error Concealment Artifacts Assessment Module comprises
a. analyzer for analyzing a coded video input, wherein typical features of the coded video input are obtained;
b. comparator for comparing the typical features of the coded video input with the calculated typical features obtained from the Typical Features Calculation module; and
c. assessment module for determining, depending on the result of said comparing of the comparator, a video quality of the coded video input, wherein a numeric quality score is assigned to the coded video input.
